(19) United States
(12) Patent Application Publication
(10) Pub. No.: US 2009/0107862 A1
(43) Pub. Date: Apr. 30, 2009

(54) Fraud resistant stored value card and carrier system

(76) Inventors: Shelle B. Pascua, Sherwood, OR (US); Amy Elizabeth Paldi-Camp, Portland, OR (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/977,755

(22) Filed: Oct. 24, 2007

(51) Int. Cl. B65D 85/00; B42D 15/10

(52) U.S. Cl. 206/232; 283/62

(57) ABSTRACT

A stored value card and carrier system including at least two panels such that raised or embossed account identifying element on the card is covered by at least one layer of the carrier system. A stored value card and carrier system including a removable portion(s) that form(s) an envelope for the card when removed, and that may have an account identifying element on the removable portion.

### FIELD OF THE INVENTION

The invention relates generally to stored value cards, and more particularly relates to a system used for packaging such cards to help prevent fraudulent use of information on such cards.

### BACKGROUND OF THE INVENTION

Stored value cards, which may also be known as gift cards, prepaid cards, shopping cards or fare cards, prepaid Mastercard™ and Visa™ cards (instant issue) among other names, are very popular with both consumers and retailers. The wide appeal of stored value cards, as a result, has attracted the unwelcome attention of criminals seeking to exploit the conveniences and automated processes afforded by such cards. In particular, such criminals misappropriate and manipulate stored value cards and associated account information to perform fraudulent transactions.

A stored value card is typically the size and shape of a conventional credit card (CR80 Card) and includes a magnetic stripe, bar code or other similar activation method, account identifying element, or means for using the card. The stripe, code, account identifying element, etc. on the card is encoded with data, which includes a unique account number. The account identifying element, for example, may be visible while the card is secured in or secured to packaging, such that the account identifying element may be used during the purchase and activation of the card.

Commonly, stored value cards are displayed by retailers for purchase by customers. The cards are stored in an inactive state and in that state cannot be used to purchase goods or services. A customer can get a card activated by bringing a card to a cashier and having the cashier then swipe the card through a point of sale terminal, which may add value to the card in exchange for payment, or activate value already on the card. A balance on the card may be maintained within a computer system located at the point of sale or at a remote location. A holder of the stored value card may then use the card to purchase goods and/or services immediately or over time up to the value of the card. These current procedures relating to stored value cards, although providing convenience to consumers, leave the cards vulnerable to criminals.

One particular fraud that is perpetuated by criminals with regard to stored value cards is called “skimming.” Skimming is a serious problem resulting in significant loss to both retailers and consumers. To skim a card having a magnetic stripe holding account information, for example, a criminal will purchase a stored value card from a retailer, thereby causing an account associated with the card to become activated. The criminal will then remove additional cards from the store that have not yet been activated, and will then alter magnetically stored information on the inactivated cards to match that of the activated card. As such, all of the altered, inactivated cards will have the magnetic information that identifies the account of the originally purchased card. The criminal will then return the altered cards to the store shelf where unsuspecting customers seeking to purchase a stored value card will unknowingly place money into the account of the criminal holding the originally purchased card. The unsuspecting customer may attempt to use their card and will be told that it has no associated value or has a smaller value than thought. The retailer may be able to verify that the customer did not use the value associated with the stored value card, and in the interest of customer service, may restore the value to the customer. In that case, the retailer loses the money. However, in some cases, there may be no way to prove fraud and the customer may lose the entire value.

Another fraud perpetuated by criminals is carried out by the criminal viewing stored value cards in the store. The criminal writes down the code associated with the particular stored value card (such as a credit card type number) while it is still in the store. In such situations the code is in plain view of the criminal or may be easily viewed without altering the card packaging. Once the criminal has recorded the code, the criminal waits for a period of time, assuming that an unsuspecting customer will purchase and have the card activated during that time. The criminal then periodically checks to see if they are able to make purchases, such as online purchases, by attempting to use the card code. If the card has been activated by the true purchaser, the criminal will be able to purchase goods online using the activated code, thereby stealing the balance on the card from the true purchaser.

Even if a code associated with a stored value card is covered or hidden from view, it is possible that a fraud may be perpetuated by a criminal with regard to a stored value card having an embossed code number. A criminal may run his or her finger over the outside of the packaging above where the embossed code number is located on the card, and may memorize or write down the number for future attempts at fraudulent purchases.

Criminals may perpetuate the above-described frauds or other frauds with regard to stored value cards as they sit on store shelves today. Thus, there is a need for a way to protect such cards and insure that they have not been tampered with or duplicated prior to purchase or activation by an innocent consumer.

There have been proposals and attempts to reduce the occurrence of fraud associated with stored value cards. For example, modifications to card readers or other parts of the activation process have been proposed, but changing existing systems in such ways involves significant cost. Additional steps have been added to the activation process for some cards, such as steps involving pin numbers and web access. However, additional steps reduces the level of convenience that such cards provide to consumers.

Overall, there is a need for a way to prevent fraud relating to stored value cards that is effective, and inexpensive to implement, while at the same time not negating the convenience of stored value cards.

### SUMMARY OF THE INVENTION

One aspect of the invention is a stored value card and carrier system. One embodiment of such a stored value card and carrier system comprises: an inactive stored value card, wherein the inactive stored value card includes at least one raised or embossed account identifying element in order to identify the account and conduct transactions against the account; and a carrier comprising at least two panels; and wherein the at least one raised or embossed account identifying element is covered by at least one layer of the carrier system. The card may be affixed to a card carrier portion that is substantially the same size and shape as the card. The system may further comprise a removable portion that forms an envelope for the card. The removable portion may include at least three panels forming the envelope. The stored value card has a type associated therewith, and wherein the type is selected from the group consisting of a gift card, loyalty card, credit card, debit card, health card, phone card, pre-paid phone case, membership card, identification card, or ring tone card. The system may further comprise an adhesive, wherein the card is attached to the carrier using the adhesive such that upon removal of the card from the carrier, the carrier is damaged to indicate the removal. The system may further comprise an adhesive, wherein the at least two panels are attached to one another using the adhesive such that upon removal of the panels from each other, the carrier is damaged to indicate the removal. One or both of the card and carrier may include printing.

An alternative embodiment of a stored value card and carrier system comprises: a stored value card, wherein the stored value card includes at least one account identifying element in order to identify the account and conduct transactions against the account; and a carrier comprising at least one panel; and a removable portion that forms an envelope for the card when removed. The carrier may comprise at least two panels; and wherein the at least one account identifying element may be raised or embossed and covered by at least one layer of the carrier system. The removable portion may include at least three panels forming the envelope. The stored value card may have a type associated therewith, and wherein the type is selected from the group consisting of a gift card, loyalty card, credit card, debit card, health card, phone card, pre-paid phone case, membership card, identification card, or ring tone card. The system may further comprise an adhesive, wherein the card is attached to the carrier using the adhesive such that upon removal of the card from the carrier, the carrier is damaged to indicate the removal. The system may further comprise an adhesive, wherein there are at least two panels of the carrier that are attached to one another using the adhesive such that upon removal of the panels from each other, the carrier is damaged to indicate the removal. One or both of the card and carrier include printing. The removable portion may include apertures for hanging the system in a retail display.

Yet another embodiment is a stored value card and carrier system, said system comprising: an inactive stored value card, wherein the inactive stored value card includes at least one account identifying element in order to identify the account and conduct transactions against the account; a carrier comprising at least two panels; and a removable portion of the carrier having at least one account identifying element, the removable portion when removed from a main portion of the carrier enables the formation of an envelope for the card. The removable portion may comprise a hanging aperture configured to be used to hang the carrier on a display rack. After the removable portion is removed, no hanging aperture is on the envelope or no account identifying element is visible on the envelope. The activation identification symbol may comprises at least one of a magnetic strip, a bar code, or text.

### BRIEF DESCRIPTION OF THE DRAWINGS

The above mentioned and other advantages of the invention, and the manner of attaining them, will become more apparent and the invention itself will be better understood by reference to the following description of the embodiments of the invention taken in conjunction with the accompanying drawings, wherein:

FIG. 1 is a top plan view of an exemplary card and carrier system in accordance with an embodiment of the invention;

FIG. 2 is a bottom plan view of the embodiment of FIG. 1;

FIG. 3 is a bottom plan view of an exemplary card and carrier system in accordance with an alternative embodiment of the invention;

FIG. 4 is a top plan view of an exemplary card and carrier system in accordance with another alternative embodiment of the invention;

FIG. 5 is a bottom plan view of the embodiment of FIG. 4;

FIG. 6 is a bottom plan view of the card and carrier system of FIG. 5 in a folded position;

FIG. 7 is a top plan view of the card and carrier system of FIG. 4 in a folded position;

FIG. 8 is an exemplary top plan view of a tear out card carrier in accordance with an exemplary embodiment;

FIG. 9 is an exemplary bottom plan view of the tear out carrier of FIG. 8; and

FIG. 10 is an exemplary top plan view of an exemplary card and carrier system in accordance with yet another alternative embodiment of the invention.

### DETAILED DESCRIPTION OF PREFERRED EMBODIMENTS

The embodiments of the invention described below are not intended to be exhaustive or to limit the invention to the precise forms disclosed in the following detailed description. Rather the embodiments are chosen and described so that others skilled in the art may appreciate and understand the principles and practices of the invention.

The invention is a fraud resistant stored value card and carrier system and related methods. Before describing in detail the stored value card and carrier system and related methods, it should be observed that the invention is not limited to the particular embodiments depicted in the exemplary figures, but should be construed in accordance with the language in the claims.

An advantage of the invention is that only the carrier part of a stored value card system needs to be changed from those in existing systems in order to help prevent fraud. Such a change is easy to implement in existing systems. Therefore, the cost of implementing such a change to existing systems is low. Another advantage is that the changes to the carrier are effective to help prevent fraud. In addition, the invention provides tamper evident features to prevent fraud, but also allows those tamper evident areas to be later removed from an envelope for the card that may be used for gift-giving purposes.

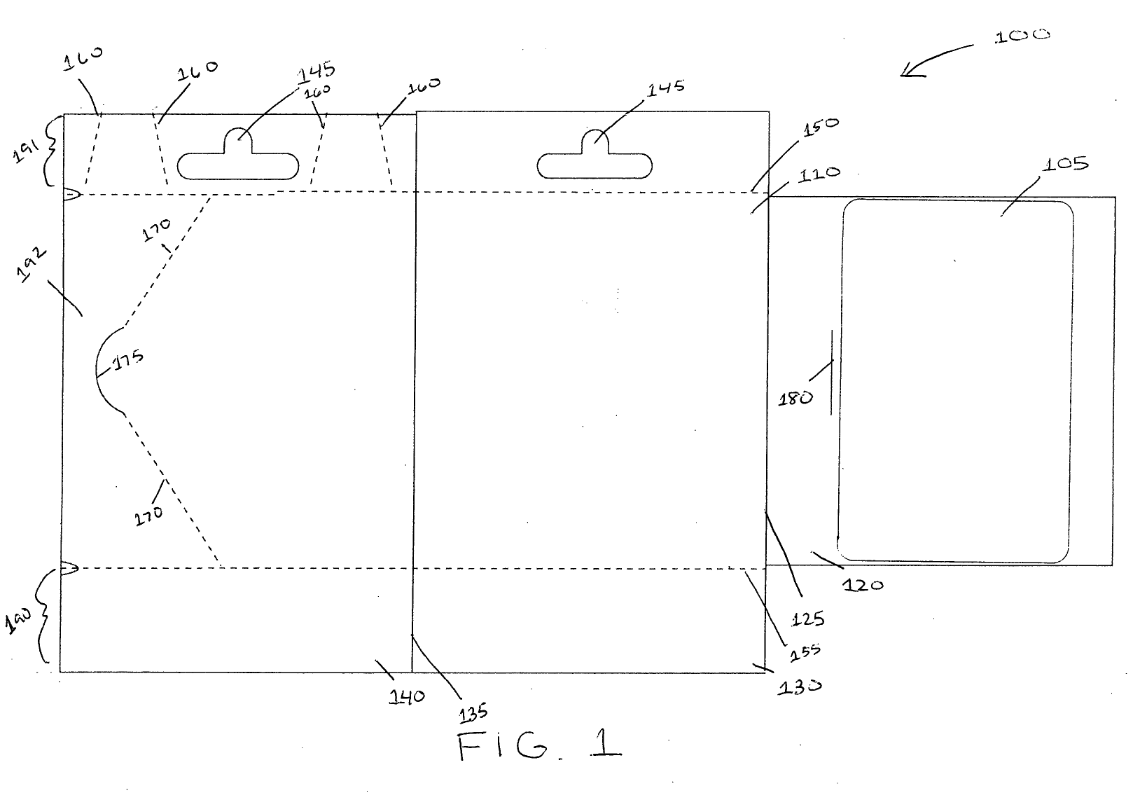

Referring now to FIG. 1, an exemplary embodiment of a stored value card and carrier system, in accordance with the invention, is depicted. FIG. 1 shows a top plan view of such a stored value card carrier and card system 100. The system 100, as shown, includes an inactive stored value card 105 securely attached to a carrier 110, which has three panels 120, 130, 140 and is bi-fold (two folds indicated by 125, 135). The means for securely attaching the card 105 to the panel 120 of carrier 110 is not shown, but may be any suitable means, such as a line or dots of adhesive, for example. The adhesive would preferably not be able to be sliced using a sharp-edged instrument without some indication of such a slice (e.g., damage resulting to the carrier). The adhesive is preferably a releasable adhesive that causes some deformation to the carrier 110 upon removal from the carrier 110. The card 105 includes at least one account identifying element (not shown) that is preferably located on the rear side of the card 105 as the card is shown in FIG. 1.

In order to enclose the stored value card 105, and thereby prevent fraud relating to the card 105, first the panel 120 is folded toward panel 130 with the card side contacting panel 130. Next, panels 130 and 140 are folded towards one another until they contact one another and sandwich panel 120. A suitable means of adhering panels 130 and 140 to each other is used, such as an adhesive. In the embodiment shown, the adhesive may be placed at a plurality of locations between panels 130 and 140, in portions 190, 191 and 192. Preferably, some adhesive is located in between each set of lines of weakness 160. The purpose of the lines of weakness 160 surrounding some adhesive is that when the panels 130 and 140 are separated in order to access the card 105, the separation will result in tearing or damage to the carrier 110 at or near the lines of weakness 160. This will evidence any possible tampering to the system 100. The shape of the lines of weakness 160 are exemplary, and other shapes are contemplated. For example, a semi-circular line of weakness may be used instead of the set of lines 160.

The carrier 110 includes optional openings or apertures 145 through the carrier 110 that can be used to hang the carrier 100, in its folded configuration while the apertures are aligned and proximate one another, in a retail establishment display. The shape of the apertures 145 shown is one alternative shape and other shapes are also contemplated.

Once the carrier 110 has been opened to access the card 105, damage will result to the carrier 110 at or near where the adhesive was applied to portions 190, 191, and 192. If the card 105 is going to be given as a gift, for example, the damage will detract from the attractiveness of the packaging. In the system 100, the portions 190, 191 and 192 may be torn or removed from the remainder of the carrier 110 at lines of weakness 155, 150 and 170, respectively. The remainder of the carrier 110 may be used as an envelope to retain the card 105. The panel 120 is folded against what remains of panel 130, and what remains of panel 140 is then placed in contact with panel 130. A tab 175 on panel 140 is then inserted into a slit or cut 180 in panel 120 in order to keep the envelope closed.

The removable portions 190, 191 and 192 preferably include the tamper evident damaged areas of the carrier after opening. Also, the portions 190 and 191 preferably also include the account identifying element and the apertures through the carrier for hanging in a display. Removal of these features make the envelope, or remainder of the carrier for the card more attractive for gift-giving purposes, for example.

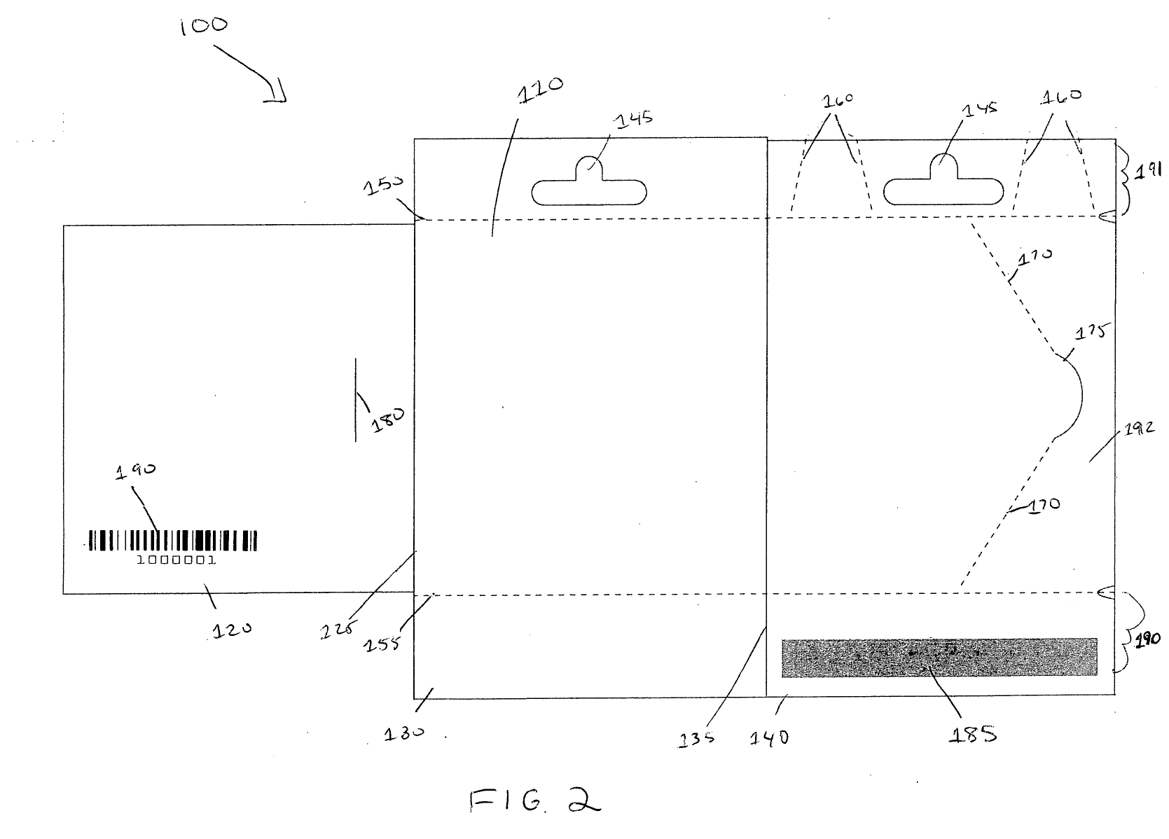

FIG. 2 is a bottom plan view of the stored value card and carrier system 100 of FIG. 1. From the bottom view, it can be seen that the outside of the carrier 110 includes a means for activating the card 105 without needing to open the carrier 110 (the activating means, also being an account identifying element). The activating means or account identifying element shown is a magnetic stripe 185, although other such means or elements are also contemplated by the invention (e.g., bar code or text). During activation of the stored value card 105, the magnetic strip 185 is read by an applicable source. The location shown in FIG. 2 is one exemplary location, with other locations on the outer surface of the carrier 110, as assembled, also being contemplated.

FIG. 2 also shows another account identifying element 190 on panel 120, which is not visible from the outside of the carrier system 100 when fully assembled and enclosing the card 105. The account identifying element 190 in this FIG. is a bar code, which may be used during the assembly process to confirm that the account information in the magnetic stripe 185 corresponds with the account information on the card 105.

The carrier system 100 securely encloses the stored value card 105 and any accompanying account identifying element(s) to prevent fraud. Activation of the card 105 is done from the outside of the carrier 110, with the card 105 and its account identifying information being protected from fraud. However, once the card 105 is purchased for gift-giving purposes, the securely enclosed configuration may not be desired. Therefore, once activation is complete, the carrier system 100 may be converted to an envelope-type enclosure to which the card 105 is attached, as described above.

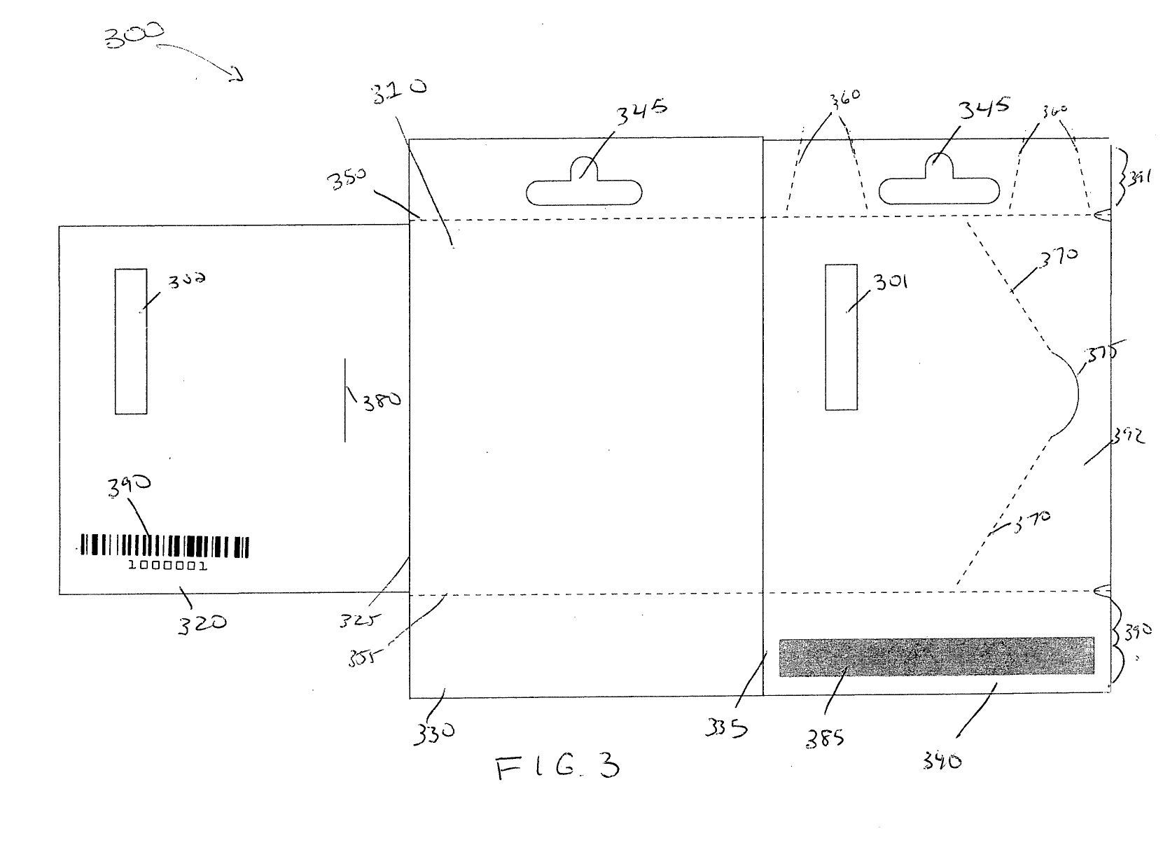

FIG. 3 illustrates an alternative carrier system 300 that is similar to the embodiment shown in FIGS. 1 and 2 except that it includes a die cut hole or aperture 301 in panel 340 and a corresponding hole or aperture 302 in panel 320. The purpose of the apertures 301 and 302 that co-align with each other is to allow some information on the card attached to the carrier 310 to be visible and accessed from the outside of the carrier 310 when in its closed configuration.

FIGS. 1-3 depict exemplary embodiments of the stored value card and carrier system of the invention. The components shown and provided above are illustrative and alternative and/or additional components are also contemplated by the invention. Some of the main components shown will, however, be described in more detail below.

The stored value card 105 shown in FIG. 1 is one example of a stored value card contemplated by the invention. In general, stored value cards are forms of transaction instruments associated with transaction accounts, wherein the stored value cards provide cash equivalent value that may be used within an existing payment/transaction infrastructure. Stored value cards are frequently referred to as gift, pre-paid or cash cards, in that money is deposited in an account associated with the card before use of the cards is allowed. In general, such an account may be used for transactions between a user and a merchant through any suitable communication means, such as, for example, a telephone network, intranet, the global, public Internet, a point of interaction device, online communications, off-line communications, wireless communications, and/or the like (and in person . . . point of sale device). The type of stored value card may be a gift card, loyalty card, credit or debit card, health card, phone card, pre-paid phone card, membership card, identification card, ring tone card, or any other type of card. The stored value card of the invention may be any such transaction instrument associated with any such transaction account.

The stored value card is typically the size and shape of a conventional credit card (i.e., CR80), although other sizes and shapes are contemplated by the invention. The stored value card is commonly made of plastic, wood, or paper, however other materials, such as other synthetic or natural materials are also contemplated.

The stored value card includes an account identifying element, such as a magnetic stripe, radiofrequency identification (RFID), bar code, text (recognized by Optical Character Recognition (OCR)), for example. The account identifying element is encoded with data, which includes a unique account number. If the stored value card includes a magnetic stripe, that magnetic stripe may comprise a plastic film including tiny magnetic particles that can be magnetized in certain directions to record data on the card, which may be read by a card reader. If the stored value card includes a bar code, the bar code may comprise machine-readable data, which may be alpha-numeric. Bar code data includes black and white lines arranged to represent a series of numbers (e.g., a bar code comprising a Universal Product Code (UPC) has twelve digits) to a bar code scanner (printed account identifying elements). Other current or future developed account identifying elements are also contemplated by the invention. Also, it is contemplated that more than one account identifying element may be included on the stored value card of the invention, and in any location.

The stored value card 105 may included embossed or non-embossed features. An account identifying element(s) on the card 105 may be embossed (including at least one raised portion (e.g., letters, designs), or protuberance, etc.), or non-embossed.

The stored value card 105 in FIG. 1 is secured to the carrier 110 or 310 such that the account identifying element is adjacent to the carrier 110 or 310, and the account identifying element is not able to be viewed while the card 105 is attached to the carrier 110 or 310. The stored value card 105 has two sides and is attached to the carrier 110 or 310 such that the side including the account identifying element is facing the carrier 110 or 310. The card 105 is securely attached by a suitable adhesive or attachment means (not shown). The adhesive or other means of attachment should permit the card 110 to be removed after purchase while providing some indication that the card 105 has been removed from the carrier 110 or 310 (e.g., damage to the carrier 110 or 310). The purpose of using such an adhesive or other method of attachment is to retain the card 105 in the carrier 110 or 310, and may also be to prevent the card 105 from being partially or totally removed from the carrier 110 or 310 by someone intending to access the account identifying element for fraudulent purposes, and then being reattached. If the card 105 is removed in order to perpetuate fraud, such a suitable adhesive will, for example, cause damage to the carrier 110 or 310 to indicate to potential purchasers and to retail workers that the card 105 has been tampered with. The adhesive may be applied in a line or dots length-wise along the card 105 between the card 105 and the carrier 110 or 310 in order to attach the two components. Other configurations or applications of a suitable attachment means or adhesive, however, are also contemplated.

The carrier 110 or 310 in FIGS. 1-3 is made up of three panels and one single piece of a material. Other constructions are also contemplated, however, that may be made of more than one panel with folds between the panels or of more than one piece of material. Preferably, the carrier 110 or 310 is made of lightweight cardboard or paper, however other materials, such as plastic or synthetic paper, are also contemplated. The material may optionally be laminated on one or more sides thereof with a transparent material capable of receiving printed material. The laminating material may be a plastic material such as polyvinyl chloride (PVC), polyethylene terephthalate (PET), polyethylene terephthalate glycol (PETG), or acrylonitrile butadiene styrene (ABS). The laminating material may be bonded or applied to the sheet of material in a conventional matter as is well known in the art. The purpose of the laminating layer is to provide the carrier 110 or 310 with a certain degree of rigidity, which facilitates the handling thereof.

Preferably, the material used to form the carrier 110 or 310 will incur damage if the card 105 is partially or totally removed from the carrier 110 or 310. The purpose of using such a material is to indicate any tampering that may have occurred with the card 105.

While not shown in FIGS. 1-3, the front and/or rear of the system 100 or 300 (card and/or carrier) may be printed with information to promote the card when it is displayed at a retail establishment location, such as the name or logo of the retail establishment, a predetermined amount or value of the card, and so forth.

FIGS. 1-3 show lines of weakness (150, 155, 160, 170, 350, 355, 360, 370). The lines of weakness may be formed by scoring, perforating, die cutting, or any other manner as is well known in the art. The lines of weakness may define a certain portion of the carrier (110 or 310) that may be desired to be removed from the remainder of the carrier. Alternatively, the lines of weakness (160 or 360) define an area of carrier near which adhesive is applied to adhere two panels of the carrier together. Such lines of weakness (160 or 360) allow the carrier 110 to be more easily damaged when the panels are detached in order to access the card 105 and account information, thereby indicating possible tampering.

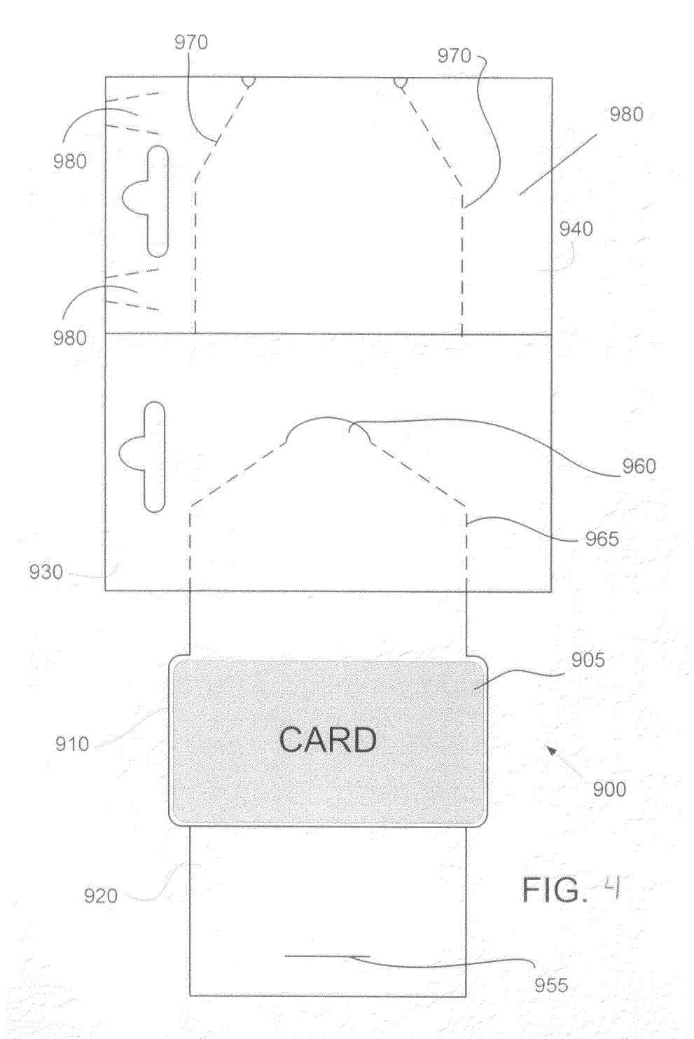

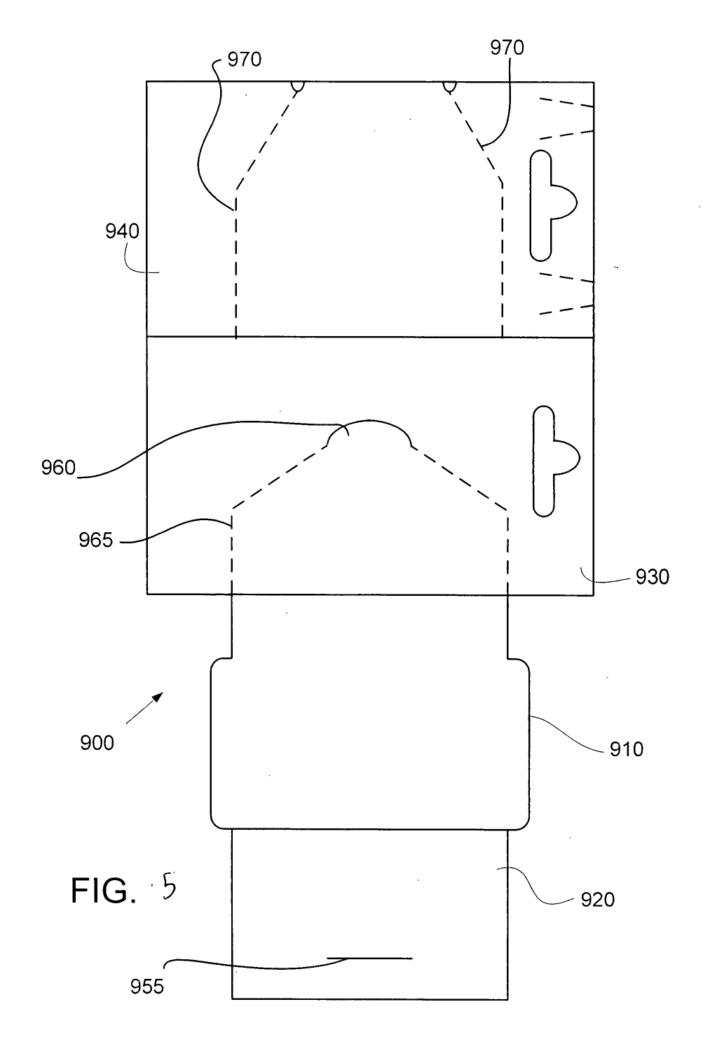

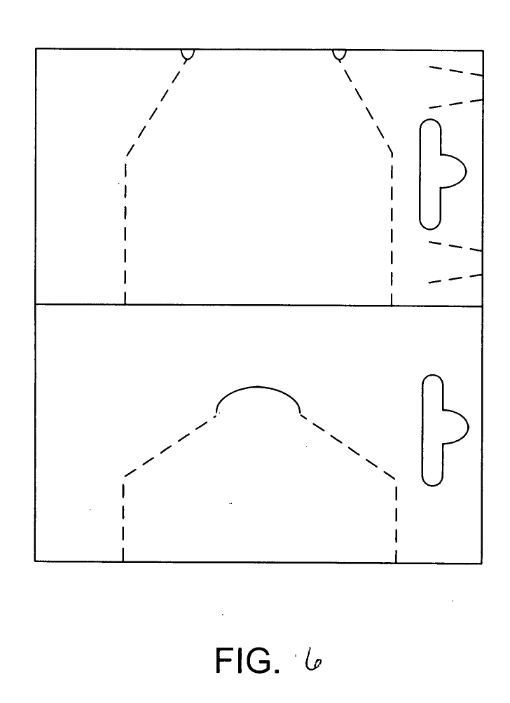

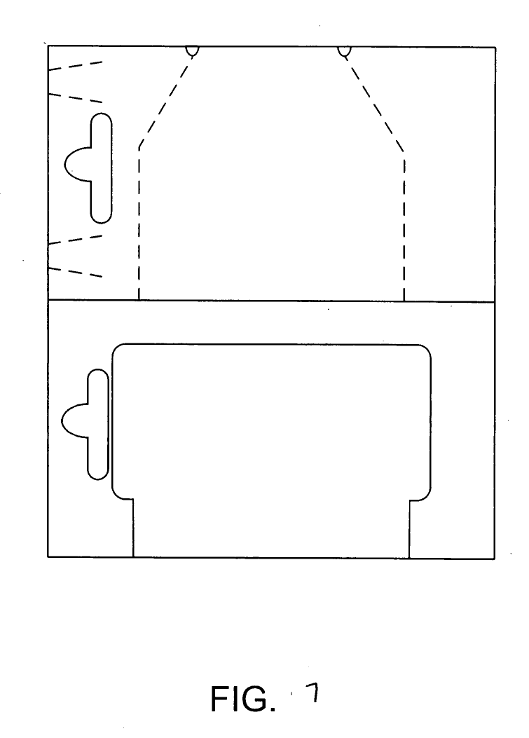

Referring now to FIGS. 4 and 5, an alternative embodiment of a card carrier system 900 is depicted. Card carrier system 900 includes a card carrying area 910 to which a card 905 may be affixed by any of a variety of means including but not limited to adhesives. Area 910 may be configured to be substantially the same size and shape as card 905. Card 905 may be a credit-card type of card in which numbers or other identifiers may exist as raised or embossed indicia. Fraudulent actors have been known to feel or press on outer portions of card carriers in conventional card carriers to reveal the embossed or raised indicia without opening the carrier. Accordingly card carrier 900 includes a fold over portion 955 which adds an additional layer of protection making it more difficult for a fraudulent actor to reveal the indicia without opening the card carrier. Fold over portion 920 which includes a slit 955 may be folded over card 910. Portion 910 may then be folded to overlay card carrier portion 930 as depicted in both of FIGS. 6 and 7. Once portions 910 and 920 overlay portion 930, portions 930 and 940 may be folded together in a sandwich-like fashion and adhered using adhesive or other adhering means. Adhesive may be placed on areas 980 to hold portions 930 and 940 together and to prevent tampering in a manner as discussed above.

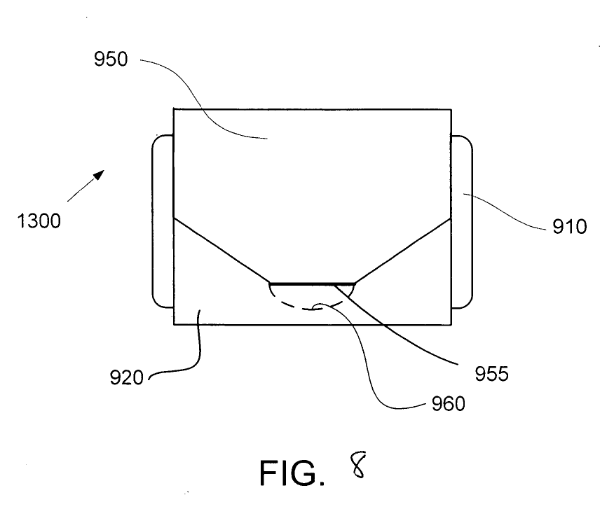

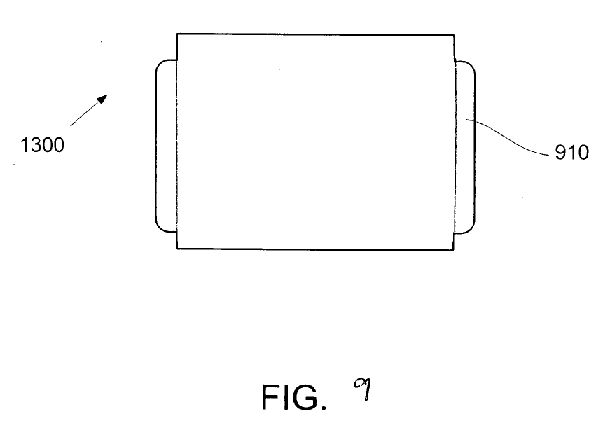

An exemplary feature of card carrier 900 is the ability to tear out a card carrier envelope after the card has been purchased such that the card may be given as a gift in a decorative envelope. Perforated lines 970 and lines 965 allow the envelope carrier to be removed from portions 930 and 940 (see FIG. 5). Once removed, the card is encased in an envelope 1300 as depicted in FIGS. 8 and 9. FIG. 8 depicts the rear side of the envelope in which tab 960 has been slid into slit 955 to hold the envelope flap in place. FIG. 9 depicts the front portion of envelope 1300 which is the rear side of portion 910.

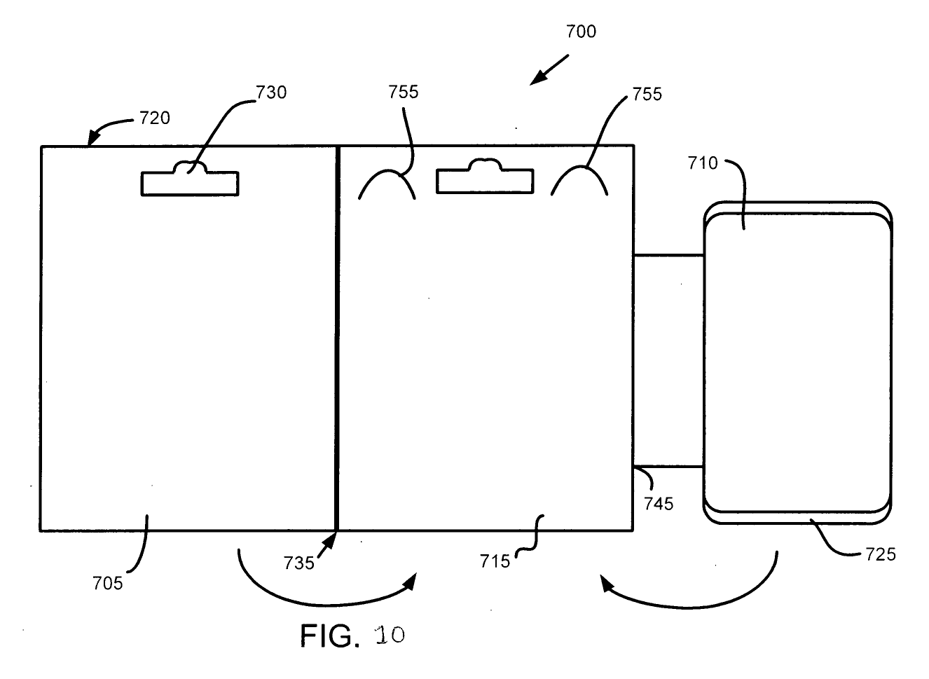

Another embodiment of the invention is shown in FIG. 10 as card and carrier system 700. The system 700 has a carrier 720 with a bi-fold (fold indicated by 735, 745), three-panel design that sandwiches the stored value card 710, mounted on another panel 725, between two panels 705 and 715. The purpose of sandwiching the card 710 is to cover any account identifying elements on the card 710 from view and/or to cover any embossed account identifying elements with at least one panel of carrier material, therefore preventing fraud. Adhesive is used to hold panels 705 and 715 together in order to enclose the card 71 and panel 725 to which the card 710 is attached. In particular, the embodiment shows semi-circular-shaped lines of weakness 755 that may further indicate tampering if adhesive near the lines of weakness 755 was cut or damaged in any way during fraudulent attempts to access account information relating to the card 710. The shape of the lines of weakness 755 are exemplary, and other shapes are also contemplated. The carrier 720 includes hanging apertures 730 for retail display purposes.

With regard to components in system 900 (FIGS. 4-9) and system 700 (FIG. 10), the discussion above with regard to systems 100 and 300 in FIGS. 1-3 that have similar or corresponding components in systems 300 and 700, also applies to those corresponding components (e.g., the store value card).

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

What is claimed is:

1. A stored value card and carrier system, said system comprising:
an inactive stored value card, wherein the inactive stored value card includes at least one raised or embossed account identifying element in order to identify the account and conduct transactions against the account; and
a carrier comprising at least two panels; and
wherein the at least one raised or embossed account identifying element is covered by at least one layer of the carrier system.

2. The system of claim 1, wherein the card is affixed to a card carrier portion that is substantially the same size and shape as the card.

3. The system of claim 1, further comprising a removable portion that forms an envelope for the card.

4. The system of claim 3, wherein the removable portion includes at least three panels forming the envelope.

5. The system of claim 1, wherein the stored value card has a type associated therewith, and wherein the type is selected from the group consisting of a gift card, loyalty card, credit card, debit card, health card, phone card, pre-paid phone case, membership card, identification card, or ring tone card.

6. The system of claim 1, further comprising an adhesive, wherein the card is attached to the carrier using the adhesive such that upon removal of the card from the carrier, the carrier is damaged to indicate the removal.

7. The system of claim 1, further comprising an adhesive, wherein the at least two panels are attached to one another using the adhesive such that upon removal of the panels from each other, the carrier is damaged to indicate the removal.

8. The system of claim 1, wherein one or both of the card and carrier include printing.

9. A stored value card and carrier system, said system comprising:
a stored value card, wherein the stored value card includes at least one account identifying element in order to identify the account and conduct transactions against the account; and
a carrier comprising at least one panel; and
a removable portion that forms an envelope for the card when removed.

10. The system of claim 9, wherein the carrier comprises at least two panels; and
wherein the at least one account identifying element is raised or embossed and covered by at least one layer of the carrier system.

11. The system of claim 9, wherein the removable portion includes at least three panels forming the envelope.

12. The system of claim 9, wherein the stored value card has a type associated therewith, and wherein the type is selected from the group consisting of a gift card, loyalty card, credit card, debit card, health card, phone card, pre-paid phone case, membership card, identification card, or ring tone card.

13. The system of claim 9, further comprising an adhesive, wherein the card is attached to the carrier using the adhesive such that upon removal of the card from the carrier, the carrier is damaged to indicate the removal.

14. The system of claim 9, further comprising an adhesive, wherein there are at least two panels of the carrier that are attached to one another using the adhesive such that upon removal of the panels from each other, the carrier is damaged to indicate the removal.

15. The system of claim 9, wherein one or both of the card and carrier include printing.

16. The system of claim 9, wherein the removable portion includes apertures for hanging the system in a retail display.

17. A stored value card and carrier system, said system comprising:
an inactive stored value card, wherein the inactive stored value card includes at least one account identifying element in order to identify the account and conduct transactions against the account;
a carrier comprising at least two panels; and
a removable portion of the carrier having at least one account identifying element, the removable portion when removed from a main portion of the carrier enables the formation of an envelope for the card.

18. The stored value card of claim 17, wherein the removable portion comprises a hanging aperture configured to be used to hang the carrier on a display rack.

19. The stored value card of claim 18, wherein after the removable portion is removed, no hanging aperture is on the envelope or no account identifying element is visible on the envelope.

20. The stored value card of claim 17, wherein the account identifying element comprises at least one of a magnetic strip, a bar code, or text.
